(19) United States
(12) Patent Application Publication
(10) Pub. No.: US 2009/0136731 A1
(43) Pub. Date: May 28, 2009

(54) SCINTILLATOR CRYSTALS AND METHODS OF FORMING

(75) Inventors: Vitali Tatartchenko, Puteaux (FR); Steven A. Zanella, Dublin, NH (US); John W. Locher, Amherst, NH (US); Christopher D. Jones, Amherst, NH (US); Damien Pauwels, Mandelieu La Napoule (FR)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: SAINT-GOBAIN CERAMICS & PLASTICS, INC., Worcester, MA (US)

(21) Appl. No.: 12/255,744

(22) Filed: Oct. 22, 2008

Related U.S. Application Data
(60) Provisional application No. 60/981,983, filed on Oct. 23, 2007.

(51) Int. Cl. C01F 17/00; B32B 9/00

(52) U.S. Cl. 428/220; 423/263

(57) ABSTRACT

A scintillator crystal and a method for growing a scintillator crystal are provided which includes an as-grown Edge-defined Film-fed Growth (EFG) single crystal. The as-grown EFG single crystal has a body having a thickness, a width, and a length, such that the thickness≦width<length, and the body has a cross-sectional area perpendicular to the length of not less than about 16 mm².

### CROSS-REFERENCE TO RELATED APPLICATION(S)

The present application claims priority from U.S. Provisional Patent Application No. 60/981,983, filed Oct. 23, 2007, entitled “Scintillator Crystals And Methods Of Forming,” naming inventors Vitali Tatartchenko, Steven A. Zanella, John W. Locher, Christopher D. Jones, and Damien Pauwels, which application is incorporated by reference herein in its entirety.

### BACKGROUND

1. Field of the Disclosure

The present disclosure is directed to single crystals, and particularly directed to single crystals comprising rare earth silicate compositions and methods of forming same.

2. Description of the Related Art

Certain crystal compositions are useful as scintillation materials that can be used in detector applications ranging from nuclear physics, medicine, to more industrial applications such as mining and drilling. Currently, the medical industry has shown much interest in certain rare earth silicates, such materials having potentially desirable properties in the form of scintillating single crystal components. Such properties include quick decay times (fast), radiation capture efficiency (density), light intensity (bright), and reduced pixel cross talk. However, challenges continue to exist in the quest for commercialization of such promising materials.

Typically, the scintillator crystals and particularly single crystals of rare earth silicates are grown using the Czochralski method, in which, a seed crystal for initiating a preferred structural growth makes contact with a melt containing a rare earth silicate composition, and the seed crystal is pulled from and rotated with respect to the melt to form a cylindrical boule of single crystal material. While prior art methods can produce single crystal rare earth silicates, the industry continues to demand high quality scintillator crystals and methods of forming same.

### SUMMARY

According to a first aspect, a scintillator crystal is disclosed which includes an as-grown Edge-defined Film-fed Growth (EFG) single crystal. The as-grown EFG single crystal has a body having a thickness, a width, and a length, such that the thickness≦width≦length, and the body has a cross-sectional area perpendicular to the length of not less than about 16 mm².

According to a second aspect, a method of forming a scintillator crystal is disclosed which includes providing a melt within a capillary and a shaping channel of a die. The die is disposed within a crucible containing the melt, and the melt defines a melt surface within the crucible. The method further includes drawing a single crystal comprising out of the melt from the shaping channel of the die, such that the single crystal has a body having a thickness, a width, and a length, wherein the thickness≦width≦length. The body having a cross-sectional area perpendicular to the length of not less than about 16 mm².

According to another aspect a rare earth silicate scintillator single crystal is disclosed, the single crystal having a body, wherein the body has a thickness, a width, and a length, wherein the thickness≦width≦length. The body further includes a first end and a second end separated from the first end by the length of the body, wherein the first end comprises a first composition and the second end comprises a second composition different than the first composition by not less than one element.

According to another aspect, an Edge-defined Film-fed Growth (EFG) rare earth silicate single crystal is disclosed. The rare earth silicate single crystal includes Yb and has a body, having a thickness, a width, and a length, wherein the thickness≦width≦length.

### BRIEF DESCRIPTION OF THE DRAWINGS

The present disclosure may be better understood, and its numerous features and advantages made apparent to those skilled in the art by referencing the accompanying drawings.

FIG. 1 is a flow chart illustrating a process for forming a rare earth silicate single crystal according to one embodiment.

FIG. 2 is a diagram of an Edge-defined Film-fed Growth (EFG) device for growing a rare earth silicate single crystal according to one embodiment.

FIG. 3 is a cross-sectional illustration of a crucible, die, capillary and shaping channel according to one embodiment.

FIG. 4 is an illustration of a capillary and shaping channel according to one embodiment.

FIG. 5 is a cross-sectional illustration of a capillary and shaping channel according to one embodiment.

FIG. 6 is a cross-sectional illustration of a capillary and shaping channel according to one embodiment.

FIG. 7 is an illustration of an as-formed single crystal having a neck portion and a body portion according to one embodiment.

FIG. 8 is an illustration of a body of a single crystal according to one embodiment.

FIG. 9 is an illustration of an as-formed single crystal having a neck portion and a body portion according to one embodiment.

FIG. 10 is an illustration of an as-formed rare earth silicate single crystal including Yb according to one embodiment.

The use of the same reference symbols in different drawings indicates similar or identical items.

### DESCRIPTION OF THE PREFERRED EMBODIMENT(S)

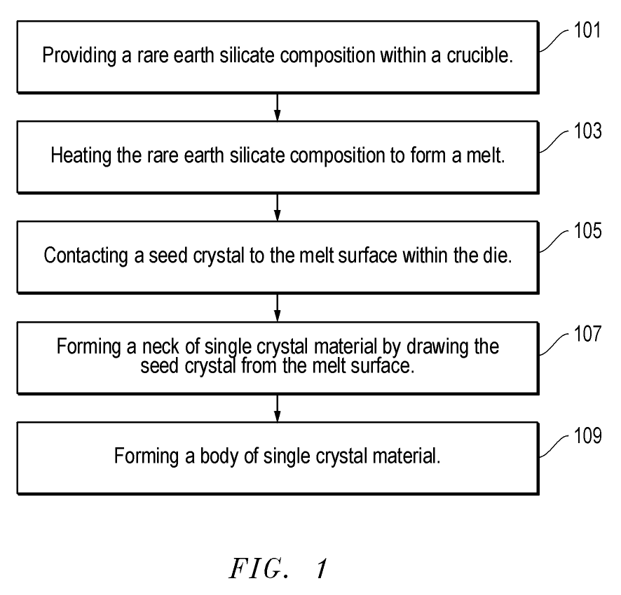

Referring to FIG. 1, a flow chart is provided that illustrates steps for forming a single crystal according to one embodiment. As illustrated in FIG. 1, the process is initiated at step 101 by providing a rare earth silicate composition within a crucible. Generally, the rare earth silicate composition is provided in a crucible in a powder or dry form at room temperature. The rare earth silicate composition can include a single homogeneous powder, or may contain a heterogeneous mixture of more than one powder, such as a combination of a rare earth silicate powder and an oxide powder.

In reference to the rare earth silicate composition, generally the silicate composition is an orthosilicate or pyrosilicate composition. As used herein, rare earth elements include elements such as Sc, Y, La, Ce, Pr, Nd, Sm, Eu, Gd, Tb, Dy, Ho, Er, Tm, Yb, and Lu. As such, the rare earth silicate composition includes one or more of such rare earth elements listed above. According to one embodiment, the rare earth silicate composition includes at least one of Lu, Gd, Y, Sc, and Ce, which are particularly effective species. For example, the silicate composition can include one or more of the particular species Lu, Gd, Y, Sc, and Ce, such that crystal compositions of LSO, LYSO, YSO, GSO, ScSO, LGSO, GYSO, and LGYSO can be formed, wherein “L” represents Lu, “Y” represents Y, “G” represents Gd, “S” represents Si, and “Sc” represents Sc.

In particular embodiments, the rare earth silicate composition can include Lu, such that the rare earth silicate is primarily a lutetium silicate, referred to as LSO. Even more particularly, in the case of LSO silicate compositions, Y can be added to form a yttrium lutetium silicate composition referred to as LYSO. Still, in LYSO compositions, the amount of Y with respect to the amount of Lu is less, such that Y is typically present in not greater than about 50 mol %. In other embodiments, the amount of Y within the silicate composition is within a range between about 5 mol % and about 20 mol %.

The rare earth silicate composition can include other inorganic materials such as additives to produce a doped single crystal. Generally other inorganic additives can include oxides, and more particularly oxides containing rare earth elements. Suitable rare earth elements include those described above, including Sc, Y, La, Ce, Pr, Nd, Sm, Eu, Gd, Tb, Dy, Ho, Er, Tm, and Yb. In one embodiment, charging of the crucible in preparation to form a melt includes provision of a rare earth oxide, or compound oxide containing one or more rare earth elements. Particularly suitable rare earth oxides comprise oxides including Gd, Y, and Ce. In one particular embodiment, an oxide compound including Ce is added to the crucible as an additive to produce a single crystal having particular scintillation properties. Provision of a minor amount of a cerium-containing inorganic additive facilitates the production of a cerium doped crystal. Generally, cerium-doped crystals, can have relatively low percentages of Ce, such as not greater than about 1 mol %. Other crystals can have a lower Ce content, such as not greater than about 0.5 mol % Ce, or not greater than about 0.2 mol % Ce.

After providing the rare earth silicate composition (and any other inorganic additives) within the crucible at step 101, the process continues at step 103 by heating the composition to form a melt. Generally, heating is carried out at a melting temperature (Tₘ) of not less than about 1800° C. In particular embodiments, the melting temperature (Tₘ) may be greater, such as not less than about 1950° C., or not less than about 2000° C., not less than about 2050° C., or even not less than about 2100° C. Heating can be completed via induction heating using coils displaced around the crucible, and generally does not exceed 2500° C. Generally, the melting temperature (Tₘ) that is utilized ensures complete melting of the composition, but Tₘ is limited so as not to unnecessarily increase the thermal budget of the process.

Upon forming a fluid melt within the crucible, the melt is also present within portions of a die within the crucible. In particular, the die includes a capillary and a shaping channel. As will be described in more detail in accompanying figures, the die includes a capillary that extends from an opening in the bottom surface of the die into an interior space within the die body. The shaping channel, extends from an opening in the top surface of the die and into an interior space within the die. The capillary and the shaping channel are connected, that is, are in communication with each other, and together form a passageway through the interior of the die. As such, upon forming a liquid melt, the melt is drawn into the die, through the capillary and into the shaping channel via capillary action.

Unlike other methods of forming single crystals, such as the Czochralski method, the present embodiments utilize particularly engineered components including the crucible, capillary, and shaping channel that were empirically developed based on extensive testing, which enable the growth of large rare earth silicate single crystals. The components particularly enable formation of a melt that initiates a capillary rise of the melt within the capillary of the die, such that the melt rises to a particular height above the surface of the melt within the crucible. Generally, the capillary rise has a height of not less than about 5.0 mm. In another embodiment, the height of the capillary rise is greater, such as not less than about 10 mm, or not less than about 15 mm, or even not less than about 20 mm. Still, the height of the capillary rise is limited, such that it is typically not greater than about 50 mm.

Generally, heating can be undertaken in a non-reactive atmosphere, such as an atmosphere containing an inert gas, a noble gas, nitrogen, or carbon dioxide. In order to provide a suitable atmosphere, before forming the rare earth silicate melt, the housing or chamber in which the melt is formed can be purged. Generally, purging includes removing the ambient atmosphere by forcing a non-reactive gas into the chamber for a duration of not less than about 10 minutes. According to one embodiment, the ambient atmosphere is purged with a non-reactive gas, such as a noble or inert gas, for a duration of not less than about 30 minutes, or not less than about 45 minutes, or even not less than about 1 hour. Still, the purging process generally does not have a duration greater than about 4 hours.

After sufficient purging, the melt can be formed in the non-reactive atmosphere. According to one embodiment, the atmosphere includes argon, such as for example, not less than about 95 vol % argon. According to a particular embodiment, the atmosphere includes not less than about 98 vol % argon, such as not less than about 99 vol % argon, or even not less than about 99.9 vol % argon. In embodiments utilizing such atmospheres, the concentration of oxygen can be reduced, such that the oxygen is not greater than about 5 vol %, or not greater than about 1 vol %, or even not greater than about 0.1 vol %. However, according to a particular embodiment, some percentage of oxygen is present, such as between about 3 vol % and about 0.1 vol % of the total volume of the atmosphere.

After forming the melt at step 103, the process continues at step 105 by contacting a seed crystal to the melt surface within the die. Typically, the seed crystal has a lattice structure and composition identical to the intended or desired composition and lattice structure of the single crystal being formed, that is, the seed crystal is a template for growth of the same type of crystal. The seed crystal is lowered and contacted to the surface of the melt within the die, and particularly the surface of the melt present within the shaping channel. During this process, the temperature is adjusted from a melting temperature (Tₘ) to a seeding temperature (Tₛ) after contacting the seed crystal to the surface of the melt. Accordingly, this seeding temperature (Tₛ) is typically not less than about 5° C. above the melting temperature (Tₘ). In one embodiment, the seeding temperature (Tₛ) is greater, such as not less than about 8° C., or not less than about 10° C., or even not less than about 15° C. above the melting temperature (Tₘ). That is for example, the seeding temperature (Tₛ) is typically within a range between about 1800° C. and about 2150° C.

Generally, the temperature is adjusted from the melting temperature (Tₘ) to the seeding temperature (Tₛ) such that a film is formed between the seed crystal and the surface of the melt within the shaping channel. The film above the surface of the melt at the seeding temperature should be of a particular height such that growth of a single crystal is initiated. Accordingly, at the seeding temperature (Tₛ), the liquid film is formed such that it is typically of a height of not less than about 0.5 mm. In other embodiments, the liquid film height can be greater, such as about 1 mm or even 2 mm. However, generally the initial liquid film formed above the melt is not greater than about 5 mm.

Upon satisfactory formation of the liquid film above the surface of the melt, the seed crystal is translated in a direction away from the surface of the melt within the shaping channel. This process marks the beginning of the formation of the neck of the single crystal material at step 107 of FIG. 1. Generally, the seed is translated at a rate of not greater than about 60 mm/hr, such as not greater than about 30 mm/hr, or not greater than about 15 mm/hr, or even not greater than about 5 mm/hr. Still, the translation of the seed crystal is suitable for facilitating timely formation of a large-scale single crystal and thus the translation rate is generally greater than about 1 mm/hr. Formation of the neck facilitates the controlled growth of single crystal which can spread to the full dimensions of the shaping channel. Moreover, a specific pull rate during the formation of the neck facilitates the formation of a quality large-sized single crystal body. A pull rate that is too great can result in the formation of defects, such as inclusions and cracks, leading to a non-uniform and potentially polycrystalline structure. However, a pull rate that is too slow can have the same effects, resulting in the formation of defects such as inclusions, cracks, and grain boundaries.

Upon continued pulling of the seed crystal, the neck widens, ideally to a width comparable to that of the shaping channel. Spreading of the neck, and particularly, spreading of the neck to those dimensions comparable to the shaping channel are desirable such that a single crystal having a body of the largest dimensions is formed. Moreover, it is desirable that the neck spreads uniformly and symmetrically to opposite ends of the die during the pulling process, such that the height difference between the initiation of the main body portion defined by the transition of opposite lateral sides of the main body is reduced.

According to one embodiment, during formation of the neck, the quality of the single crystal grown within the neck is inspected. Generally, inspection of the single crystal is done after the neck has been grown for a significant length, such as about 5 mm. If the quality of the single crystal material within the neck is not suitable, the forming process may be interrupted by breaking the film, and reinitiated by lowering the seed crystal and reforming the neck.

After forming the neck of the single crystal material at step 107, the process can continue at step 109 by forming the body of the single crystal. Typically, the body of the single crystal has dimensions greater than those of the neck, and the body forms the region of the single crystal from which one or more crystals will be harvested for particular applications. Because of the large dimensions of the single crystal being grown, the temperature is adjusted from the seeding temperature (Tₛ) to a spreading temperature (Tₛₚ) which aids the spreading of the film above the surface of the melt across the width of the shaping channel to form a single crystal body of desired dimensions. Generally, the spreading temperature (Tₛₚ) is not less than about 2° C. below the seeding temperature (Tₛ). According to a particular embodiment, the spreading temperature (Tₛₚ) is not less than about 5° C., or not less than about 8° C., or even not less than about 10° C. below the seeding temperature (Tₛ). Still, the spreading temperature (Tₛₚ) is generally not greater than about 20° C. less than that of the seeding temperature (Tₛ). That is for example, the spreading temperature (Tₛₚ) is typically within a range between about 1800° C. and about 2150° C.

During the growth process, the height of the film above the surface of the melt is controlled such that the full dimensions of the single crystal body can be grown effectively. In particular, the height of the liquid film above the surface of the melt is generally not greater than about 1 mm, or not greater than about 0.5 mm, and typically within range between about 0.2 mm and about 0.5 mm. In one embodiment, the height of the liquid film above the surface of the shaping channel is generally about 0.3 mm

The height of the film during the growth of the body of the single crystal can be controlled in part by adjusting the rate of translation of the seed crystal away from the surface of the melt. As such, the seed crystal is generally translated upwards away from the surface of the melt at a rate of not greater than about 25 mm/hr. The seed crystal can be translated at a slower rate, such as not greater than about 20 mm/hr, not greater than about 10 mm/hr, or even not greater than about 5 mm/hr. As such, the seed crystal is generally translated at a rate within a range between about 5 mm/hr to about 15 mm/hr during the growth of the body.

As will be appreciated during growth of the single crystal body, and particularly during the growth of large single crystals, the mass of the melt within the crucible will be reduced as the mass of the crystal grown is increased. In order to avoid limiting the size of the single crystal formed based upon the initial mass of material within the crucible, and in order to sustain high compositional uniformity, according to one particular embodiment, the crucible can be refilled during growth of the single crystal with more raw materials. Provision of raw materials to the melt during growth, such as through a feed tube, facilitates continuous growth of the rare earth silicate single crystal, and recharging of the melt with raw materials having a proper stoichiometry, thereby reducing the compositional variations in the grown single crystal.

A recharging process or energizing of the crucible with raw materials during the growth process facilitates the formation of large scale crystalline bodies. However, such a process is delicate, and can require adjustments in the temperature of the melt to maintain a suitable liquid phase for proper crystal growth. In certain instances of energizing processing, during recharging of the crucible, the temperature can be increased to maintain XXXXXX

Moreover, in one particular embodiment, the mass of the final-formed crystal (M_{c}) is greater than the original mass of the raw materials (Mₘ). That is, in one embodiment, the mass ratio between the final mass of the crystal to the initial mass of the raw materials (M_{c}:Mₘ) is not less than about 2:1. According to another embodiment, the mass ratio (M_{c}:Mₘ) is greater, such as not less than about 3:1, or not less than about 4:1, or even not less than about 5:1. Such a mass ratio may be accomplished by regular charging, or even continuous feeding, of raw materials to the crucible during formation of the single crystal.

Upon completion of the formation of the body, that is, when a satisfactory crystal has been formed of a suitable dimension, the single crystal body is pulled from the surface of the melt at a rate such that the liquid film is broken and the growth process is terminated. Accordingly, during this process, the seed crystal is typically pulled at a rate of not less than about 50 mm/hr away from the surface of the melt within the shaping channel. In one embodiment, the pull rate is greater, such as not less than about 75 mm/hr, or even not less than about 100 mm/hr. As such, the pull rate to end the growing process is typically within a range between about 500 mm/hr and about 5000 mm/hr.

After the formation of the single crystal body is completed, the body may undergo an annealing process. As such, the crystal can be maintained at an annealing temperature for a suitable duration in a suitable atmosphere. Generally, the annealing temperature is not less than about 1000° C. In other embodiments the annealing temperature is greater, such as not less than about 1200° C., or not less than about 1500° C., or even not less than about 1800° C. Generally, the annealing temperature is not greater than about 2000° C. Additionally, because of the dimension and composition of the single crystal body, a typical duration for annealing is at least about 30 minutes. Other embodiments utilize a greater annealing duration, such as not less than about 1 hour, or not less than about 2 hours, or even not less than about 5 hours. Generally, the annealing process is not greater than about 120 hours. The annealing atmosphere can be reducing, neutral, or oxidizing. As such, the atmosphere can include a normal atmosphere, a noble gas, carbon dioxide, or nitrogen.

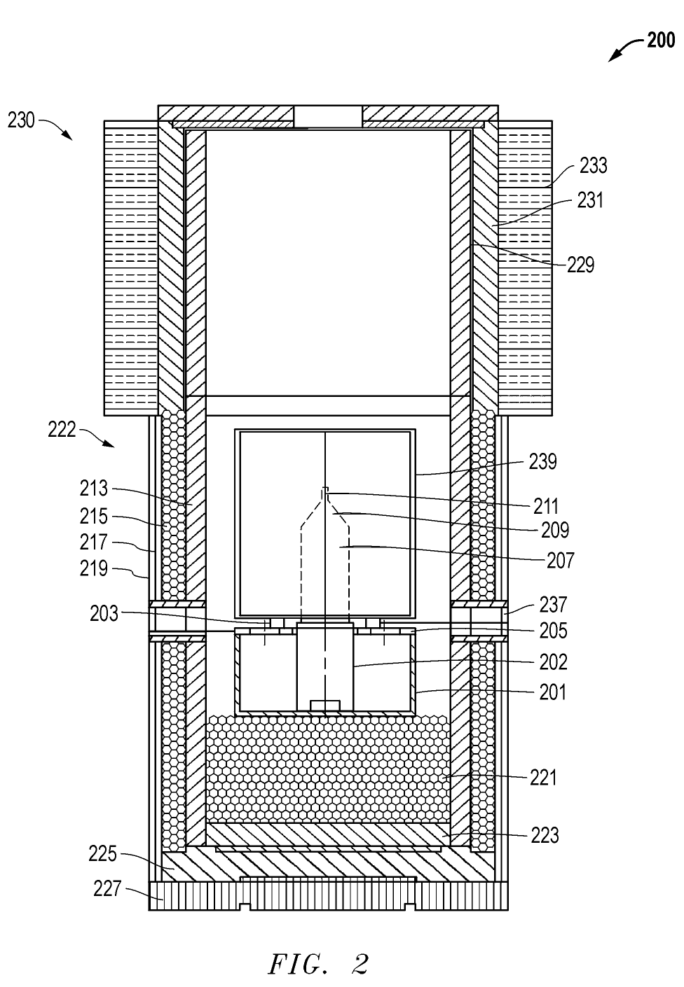

Referring to FIG. 2, a crystal growth device 200 and particularly an Edge-defined Film-fed Growth (EFG) device is illustrated. The device 200 includes in part, a crucible 201 and a die 202 disposed within the crucible. In particular reference to the crucible 201, according to a particular embodiment the crucible 201 is made of a refractory material, such as a refractory metal. Suitable refractory metals are selected based upon the wetting behavior of the metal in light of the expected composition of the melt. Particularly suitable refractory metals include tungsten, tantalum, molybdenum, platinum, nickel, iridium, and alloys thereof. According to one particular embodiment the crucible is made essentially of iridium.

In addition to the materials used within the growth device 200, the dimensions of the crucible 201 (as well as other components described herein) are particularly engineered to facilitate the growth of large single crystals. In particular, the dimensions of the crucible are not simply enlarged relative to the state of the art to grow larger single crystals. Rather, in accordance with the present embodiments, the dimensions of the crucible are particularly engineered through empirical testing to work in combination with other components such as the capillary and shaping channel, such that efficient and precise growth of large scale single crystals is facilitated. In particular, the height of the crucible is generally not greater than about 50 mm. In other embodiments, the crucible height is less, such as not greater than about 40 mm, or not greater than about 30 mm, or even not less than about 20 mm. In certain instances, the height of the crucible is within a range between about 10 mm and about 40 mm.

The crucible has dimensions to accommodate the die and may be circular or oval, for example. Additionally, certain dimensions of the crucible may be selected to accommodate certain processing requirements, for example, a crucible for use in a continuous charging processes may have a smaller diameter than a crucible for use in a single charging processes, where the crucible is not energized or refilled during the growth process. For example, the diameter (i.e., width for rectangular shaped crucibles) of the crucible in certain embodiments can be at least about 50 mm, such as at least about 70 mm, 80 mm, or even at least about 100 mm. Still, the diameter of the crucible may be limited such that it is within a range between about 50 mm and about 200 mm.

As described previously, the crystal growth device 200 includes a die 202, which can include a capillary and a shaping channel (not illustrated in FIG. 2), described in more detail in connection with the following figures. Generally, the die 202 is formed of an inorganic material, particularly a refractory material, and more particularly a refractory material having suitable wetting behavior based upon known compositions of the melt. As such, suitable refractory materials typically include refractory metals such as tungsten, tantalum, molybdenum, platinum, nickel, and iridium, and alloys thereof. According to a particular embodiment, the die 202 is made essentially of iridium.

As described above, the dimensions of certain components within the growth device 200 are particularly engineered to facilitate the growth of particular large scale single crystals. The die 202 is one such component, particularly designed to integrate with other components, such as the crucible 201, to facilitate growth of large single crystals. Accordingly, the height of the die 202 is generally not greater than about 50 mm. Still, in one embodiment, the die height is less, such as not greater than about 40 mm, or not greater than about 30 mm, or even not greater than about 20 mm. Typically, the height of the die 202 is within a range between about 10 mm and about 40 mm. The die 202, like the crucible 201, can have a generally symmetrical or polygonal cross-sectional contour, such as a circular or oval shape, for example.

In addition to the crucible 201 and the die 202, the crystal growth device 200 further includes a lid 205 and spacers 203 positioned above the crucible, as well as a thermal shield 239. According to one embodiment, each of these components, namely the lid 205, the spacers 203, and the shield 239 are formed of refractory materials, such as refractory metals. Suitable refractory metals can include metals such as tungsten, tantalum, molybdenum, platinum, nickel, iridium, and alloys thereof. According, to a particular embodiment, the lid 205, spacers 203, and shield 239 are made essentially of iridium.

As further illustrated in FIG. 2, the thermal shield 239 above the crucible 201 and the die 202 provides a controlled space and environment for pulling of a seed crystal 211 away from the top surface of the die 202 such that a neck portion 209 and a body 207 may be formed. According to a particular embodiment, the thermal shield 239 is formed such that it controls thermal gradients across the width of the single crystal body. According to a particular embodiment, the thermal shield is formed such that a thermal gradient of not greater than 50° C. exists across the width of the die 202 (center to edge). According to another particular embodiment, the thermal gradient across the width of the die 202 is less, such that it is not greater than about 10° C., or even not greater than about 5° C. Control of the thermal gradient across the die 202 facilitates controlled growth of a quality single crystal.

The crucible 201, die 202, and thermal shield 239 are disposed within a housing 222 as illustrated in FIG. 2. As illustrated, the housing 222 can include a plurality of layers, typically insulating layers, facilitating precise temperature control within the housing and thus controlled growth of large scale single crystal. The housing 222 can include an inner housing 213 of the lower portion, a first insulating portion 215 adjacent to the inner housing 213 of the lower portion, a second insulating portion 217 adjacent to the first insulating portion 215, and an outer shell 219 adjacent to the second insulating portion 217. Typically the inner housing 213, and corresponding components within the housing 222 can have a symmetrical contour, such as a circular or rectangular cross-sectional contour.

The materials comprising the insulating layers and components within the housing 222 can be particularly engineered for greater processing control. For example, the housing components can be particularly engineered in light of the composition of the melt, such that potential chemical interactions between the melt and housing components are controlled, facilitating growth of larger more homogenous single crystals. In particular, the inner housing is typically made of a refractory material, particularly a refractory ceramic material. Suitable refractory ceramics particularly include oxides, such as zirconia, alumina, and silica (e.g., quartz). According to one embodiment, the inner housing is made of zirconia, and particularly made essentially of zirconia. Such oxides can be particularly suitable, as they tend to be non-reactive within the growth environment.

In reference to the first insulating portion 215, typically the first insulation portion is disposed adjacent to the inner housing 213, and particularly in direct contact with an outer surface of the inner housing 213 of the lower portion. The first insulating portion 215 can include a refractory material, which can be a solid mass of material, or a mass of material combining refractory materials and a high degree of porosity, such as a fibrous, spongy, or reticulated material, such as for example felt, grog, fibers, or a weave. According to a particular embodiment, the first insulating portion 215 includes refractory ceramics, such as oxides. For example, suitable refractory oxides include zirconia, alumina, and silica (e.g., quartz). According to a particular embodiment, the first insulating portion 215 includes zirconia, and particularly a zirconia grog.

In reference to the second insulating portion 217, generally the second insulating portion 217 is adjacent to the first insulating portion 215, and particularly, in direct contact with the first insulating portion 215. Like the first insulating portion 215, the second insulating portion 217 can include a solid mass of material, or alternatively may combine a refractory material with a high degree of porosity. Accordingly, the second insulating portion 217 generally includes a refractory material, and particularly a refractory ceramic. As such, suitable refractory ceramics can include oxides, such as zirconia, alumina, and silica (e.g., quartz). According to a particular embodiment the second insulating portion 217 includes an alumina felt.

The housing 222 includes an outer shell 219 which is adjacent to the second insulating portion 217, and in particular, in direct contact with the second insulating portion 217. Typically the outer shell 219 is a solid material defining the outer wall of the housing 222. Accordingly, the outer shell 219 typically includes a refractory material, such as a refractory ceramic, such as an oxide. As such, suitable refractory oxides can include zirconia, alumina, and silica (e.g., quartz). According to a particular embodiment, the outer shell 219 is a quartz material, and particularly a quartz tube.

In addition to the components described, the housing 222 can include other insulating portions. As illustrated in FIG. 2, the housing 222 can further include an insulating portion 221 below the crucible 201. Accordingly, the insulating portion 221 typically includes those materials used within the first or second insulating portions 215 and 217. According to a particular embodiment, the insulating portion 221 includes a zirconia insulating material. As further illustrated in FIG. 2, the housing 222 can include a plurality of insulating base plates, notably a first insulating plate 223, a second insulating plate 225, and a third insulating plate 227. Accordingly, each of these plates 223, 225, and 227 can include refractory materials similar to those described above.

The crystal growth device 200 as illustrated in FIG. 2 can further include an upper portion 230 which includes further insulating portions to provide suitable insulation for the seed crystal 211 pulled upwards away from the surface of the die 202 by a pulling device. Accordingly, the upper portion 230 can include an outer housing 231, adjacent to but spaced apart from, the inner housing 213. The space 229 between the inner housing 213 of the portion and the outer housing 231 of the upper portion 230 allows the outer housing 231 to be translated upward, away from the housing 222 such that the seed crystal can be pulled away from the surface of the die 202. Accordingly, the outer housing 231 of the upper portion 230 can include a refractory material, such as a ceramic, and particularly an oxide. Suitable oxides can include zirconia, alumina, and silica (e.g., quartz). According to a one embodiment, the outer housing 231 of the upper portion 230 is an alumina tube.

Moreover, in addition to the outer housing 231, the upper portion 230 can include further insulation such as the outer insulation 233. The outer insulation 233 can include insulating materials such as those described above, and particularly can include refractory materials, such as oxides, like alumina, zirconia, and silica. According to a particular embodiment the insulation 233 is an alumina wool.

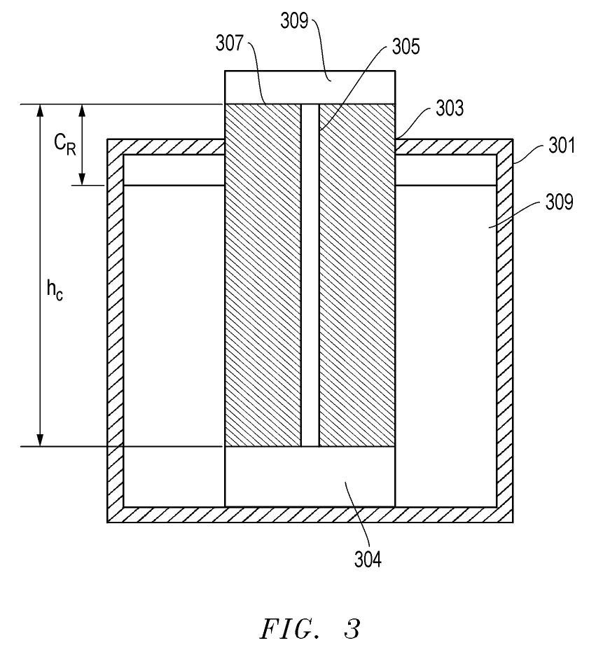

Referring to FIG. 3, a cross-sectional diagram of a crucible 301 and a die 303 are illustrated. The crucible 301 includes a melt 309 and the die 303 disposed therein. The crucible 301 and the die 303 are components that particularly support growth of large single crystals. In particular, the die 303 includes an opening 304 at the bottom portion and a capillary 305 extending from the opening 304 of the die 303 into an interior space within the die 303. The die 303 further includes a shaping channel 307 which extends from a top surface of the die 303 into an interior space of the die 303 where it is in communication with the capillary 305. Accordingly, a passageway is formed between the bottom surface and the top surface of the die 303 via the capillary 305 and the shaping channel 307. As illustrated, the melt 309 extends up the capillary 305 and into the shaping channel 307 which facilitates formation of a single crystal body comprising the composition of the melt 309. The dimensions of the capillary 305 and the shaping channel 307 are particularly designed to facilitate effective growth of a large single crystal body.

FIG. 3 illustrates a capillary 305 having a capillary height (h_{c}) which extends from the opening 304 to the shaping channel 307. Also illustrated is the height of the capillary rise (Cᵣ) which is illustrated as the distance the melt 309 rises within the capillary 305 above the surface of the melt 309 within the crucible 301. As described above, during formation of the melt, the process includes initiating a capillary rise (Cᵣ) which facilitates moving the melt 309 up the capillary 305 to the shaping channel 307 for initiation of crystal growth. The design of the capillary 305 and the shaping channel 307 within the die 303 obtain a suitable capillary rise (Cᵣ) for growth of large single crystals. Generally, the capillary rise (Cᵣ) has a height of not less than about 10 mm. In some embodiments the height of the capillary rise is greater, such as not less than about 15 mm, or not less than about 20 mm, or even not less than about 25 mm. Generally, however, the distance of the capillary rise is not greater than about 50 mm.

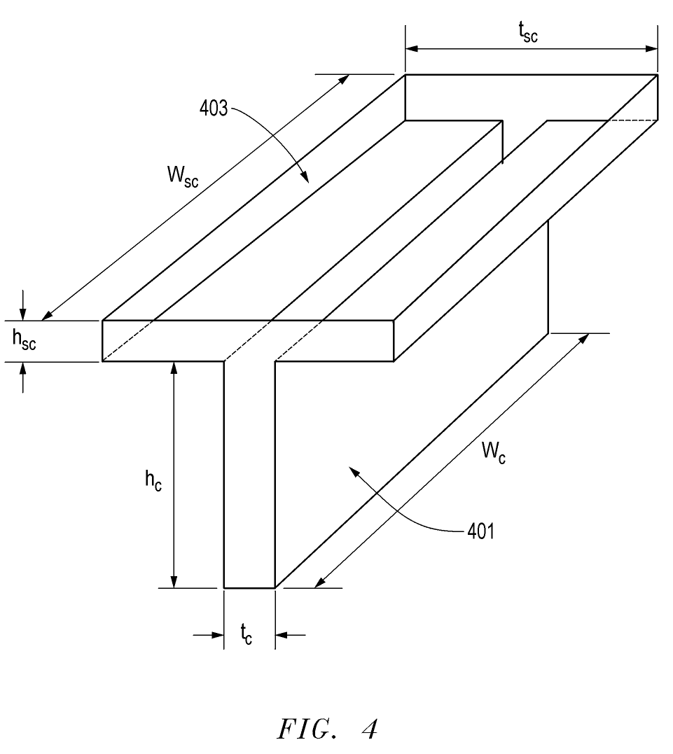

Referring to FIG. 4, a perspective view of a shaping channel 403 and capillary 401, as would be available within a die is illustrated according to one embodiment. The contours, dimensions, and materials of the capillary 401 and the shaping channel 403 facilitate the growth of large scale single crystals. In fact, these features facilitate a balance between a suitable initial capillary rise and a suitable capillary action during growth and accordingly the continuous flow of the melt during extended growth durations used to grow large scale single crystals. In more detail, the capillary 401 has dimensions of width, thickness, and height, represented by the w_{c}, t_{c}, and h_{c} respectively. As used herein, the terms “width”, “thickness”, and “height” are used as follows. The width and thickness are measurements that extend in the same plane and are substantially perpendicular to each other. Unless otherwise stated, the width is greater than the thickness. The height is a measurement that extends in a plane perpendicular to the plane formed by the width and the thickness.

According to a particular embodiment, the capillary 401 has a primary capillary ratio defined by the ratio of the height to the thickness (h_{c}:t_{c}) that facilitates growth of large rare earth silicate single crystals. Generally, the primary capillary ratio (h_{c}:t_{c}) is not greater than about 100:1. According to another embodiment, the primary capillary ratio is not greater than about 75:1, such as not greater than about 50:1, or not greater than about 20:1. According to one embodiment the primary capillary ratio is within a range between about 75:1 to about 20:1.

The height of the capillary (h_{c}) is supports sufficient initial capillary rise of the melt composition, while also facilitating the use of a particular crucible volume to facilitate growth of large single crystals. While the wetting behavior of the melt can vary depending upon a variety of factors including temperature and composition, it has been found that typically a capillary height of not greater than about 50 mm is suitable. In one embodiment the height of the capillary is less, such as not greater than about 40 mm, not greater than about 30 mm, or even not greater than about 25 mm. Typically, the height of the capillary is within a range of between about 10 mm and about 40 mm.

Moreover, the thickness of the capillary 401 is particularly designed to integrate with the other components and has dimensional features to facilitate a suitable capillary rise of a particular melt material for large scale single crystal growth. More particularly, the thickness (t_{c}) of the capillary is generally not greater than about 2 mm. According to a particular embodiment the thickness of the capillary is not greater than about 1.5 mm, such as not greater than about 1 mm, not greater than 0.8 mm, or even not greater than about 0.25 mm.

As with the other dimensional features of the capillary 401, the width of the capillary 401 is particularly designed to work in combination with the other components to facilitate a suitable capillary rise of a particular melt material for large scale single crystal growth. The capillary 401 typically has a width (w_{c}) of not greater than about 500 mm. According to another embodiment the width is not greater than about 400 mm, such as not greater than about 300 mm, or even not greater than about 200 mm. More particularly, the width of the capillary 401 can be less, such as not greater than about 100 mm, or not greater than about 75 mm, or even not greater than about 50 mm. As such, in one embodiment the capillary 401 has a width within a range between about 10 mm and about 250 mm.

As further illustrated in FIG. 4, a shaping channel 403 is disposed above the capillary 401 and in communication with the capillary 401. Like the capillary 401, the shaping channel 403 has a height (h_{sc}), a thickness (t_{sc}), and a width (w_{sc}). As used herein, the thickness (t_{sc}) of the shaping channel 403 is value of the greatest measurement in that direction. As described in accordance with the capillary 401, the composition, contours, and dimensional features of the shaping channel 403 also help facilitate suitable initial capillary rise while also maintaining a suitable continuous melt flow during the extended growth procedures used to form the large scale single crystals.

In particular, the thickness (t_{sc}) of the shaping channel 403 is generally not less than about 1 mm. More typically, the thickness is greater, such that the shaping channel 403 has a thickness (t_{sc}) of not less than about 2 mm, such as not less than about 3 mm, or about 4 mm, or even not less than about 5 mm. Still, the thickness (t_{sc}) of the shaping channel 403 is limited, such that it is typically not greater than about 30 mm, and is typically within a range between about 3 mm and about 30 mm, and more particularly within a range between about 4 mm and about 15 mm.

The height (h_{sc}) of the shaping channel 403 is generally not greater than about 10 mm. In one embodiment, the height (h_{sc}) is not greater than about 8 mm, such as not greater than about 5 mm, or even not greater than about 2 mm. Typically, the height (h_{sc}) of the shaping channel 403 is within a range between about 0.5 mm and about 10 mm.

The width (w_{sc}) of the shaping channel 403 is generally not less than about 5 mm. In one embodiment, the width (w_{sc}) is greater, such as not less than about 10 mm, such as not less than about 20 mm, or even not less than about 50 mm. Typically, the width (w_{sc}) of the shaping channel 403 is within a range between about 10 mm and about 250 mm.

While it will be appreciated, that in FIG. 4 the capillary 401 and the shaping channel 403 are illustrated to have a substantially rectangular cross-sectional contour as defined by the respective dimensions, other symmetrical or non-symmetrical polygonal contours can be formed. Particularly, the shaping channel 403 can have other contours, such as a circular cross-sectional contour, or even a contour defining an outer dimension and an “island” placed within the outer dimensions suitable for forming single crystalline shapes having hollow portions, such as a tube.

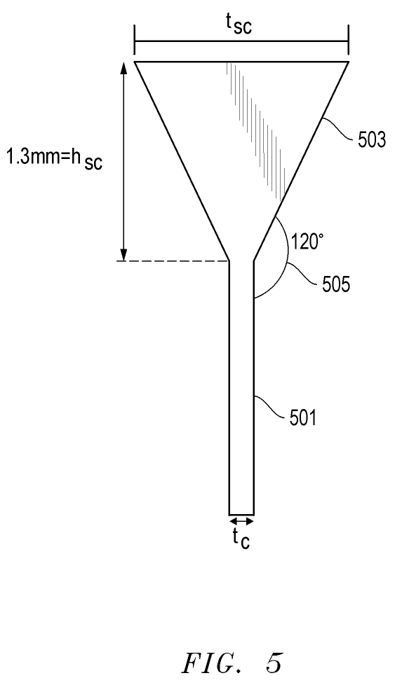

Referring to FIG. 5 a cross-sectional diagram of a capillary 501 and a shaping channel 503 is illustrated according to one embodiment. Particular contours of the shaping channel 503 have been designed to facilitate the growth of large scale single crystals. Like the other features described above, the contours are particularly designed in light of the features of the other components. For example, depending upon the design of the crucible and capillary, the contours of the shaping channel can be altered such that the melt is positioned at a suitable depth within the shaping channel to initiate film formation and growth, as well as facilitate the flow of the melt to the edges of the shaping channel for the formation of the large scale single crystal body. In this embodiment, the shaping channel 503 includes tapered sides, which extend through the height (h_{sc}) of the shaping channel 503. These tapered sides of the shaping channel 503 define an angle 505 between the sides of the capillary 501 and the sides of the shaping channel 503. Generally, the angle 505 is typically not less than about 90°. According to one embodiment, the angle 505 is not less than about 110°, such as not less than about 120°, and even not less than about 130°. According to another embodiment, the angle 505 is typically not greater than about 180°. Moreover, the angle 505 defined between the shaping channel 503 and the capillary 501 is generally within a range between about 110° and about 170° and more particularly within a range between about 130° and about 160°.

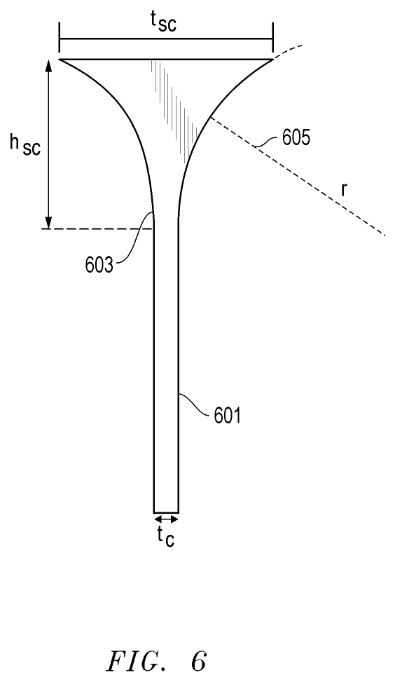

Alternative embodiments may utilize a shaping channel that has curved sides, such as for example sides that extend from the capillary in a concave or convex manner. In one particular embodiment, the shaping channel is shaped such that the sides have a convex curvature, providing small incremental changes in width as the melt rises out of the capillary and into the shaping channel. Referring to FIG. 6, a cross-sectional diagram of a capillary 601 and a shaping channel 603 are illustrated according to one particular embodiment. As illustrated, the shaping channel 603 has sides having a convex curvature. Generally, the shaping channel 603 has sides having a convex curvature defining a radius of curvature 605 of not greater than about 100 mm. According to other embodiments, the radius of curvature 605 may be less, such as not greater than about 75 mm, or not greater than about 50 mm, or even not greater than about 25 mm.

Large rare earth silicate single crystalline forms and contours can be grown using the methods and devices described above. FIG. 7 illustrates a single crystalline body 700 having a body portion 701 and a neck portion 703. Generally, the neck portion 703 is a result of the forming method and is not used as a portion for “harvesting” the as-grown single crystal. The body portion 701, however, is typically the portion of the as-grown single crystal which is used, such as to form scintillator crystals. As illustrated, the body portion 701 has a substantially rectangular contour defined by a length (l), a width (w), and a thickness (t). In the context of single crystalline bodies having a substantially rectangular contour, the cross-sectional area of the body, as measured perpendicular to the length (i.e., measurements of the two shortest dimensions, such as the width and thickness), is generally not less than about 16 mm². According to another embodiment, the cross-sectional area of the body is greater, such as not less than about 25 mm², or not less than about 50 mm², or not less than about 100 mm², or even not less than about 400 mm². Generally, the cross-sectional area of the body is within a range between about 50 mm² and about 1000 mm².

In further reference to the dimensions of the body of the as-grown single crystals, generally, the thickness not less than about 4 mm. According to a particular embodiment, the thickness may be greater such as not less than about 6 mm, or not less than 8 mm, or even not less than about 10 mm. Still, the thickness of such single crystalline bodies is limited, such that it is typically not greater than about 50 mm.

Moreover, the width of such single crystalline bodies is generally not less than about 4 mm, such that the bodies can have a square cross-sectional contour. However, some embodiments anticipate growing a single crystalline body having a more rectangular dimension, and accordingly the width can be greater, such as not less than about 10 mm, or not less than about 20 mm, not less than about 50 mm, or even not less than about 100 mm. Still, the width of such single crystals is generally not greater than about 250 mm.

In further reference to FIG. 7, large rare earth silicate single crystals grown using the devices and methods provide herein typically have a length that is greater than about 125 mm. Still, the length may be greater, such that it is not less than about 200 mm, or not less than 300 mm, or even not less than about 500 mm. Still, the length of such single crystalline bodies is limited, such that it is within a range between about 200 mm and about 1000 mm.

It will be noted that Czochralski-grown single crystals are limited in their geometries, formed in the shape of cylindrical boules and generally having a length and a diameter. While, the single crystal bodies of the present disclosure are not so limited, certain single crystal bodies can have particularly designed dimensions constructive for certain applications, particularly those grown as a sheet of single crystal material. Such sheets have a rectangular cross-sectional shape, where the thickness is less than the width and the width is less than the length (t<w<l). In the context of single crystal sheets, generally the thickness is not greater than about 80% of the measurement of the width. In other embodiments, the thickness is less, such as not greater than about 50% of the measurement of the width, such as not greater than about 30% of the measurement of the width. Unlike Czochralski-grown single crystals, the formation of a single crystal sheet reduces the post-formation processing and reduces waste, particularly in the context of the extraction of smaller single crystals for use as scintillator pixels.

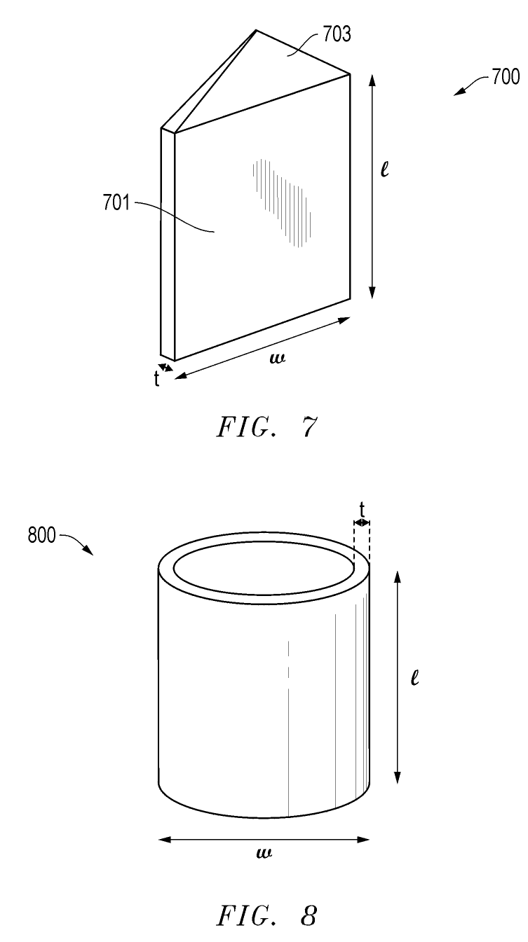

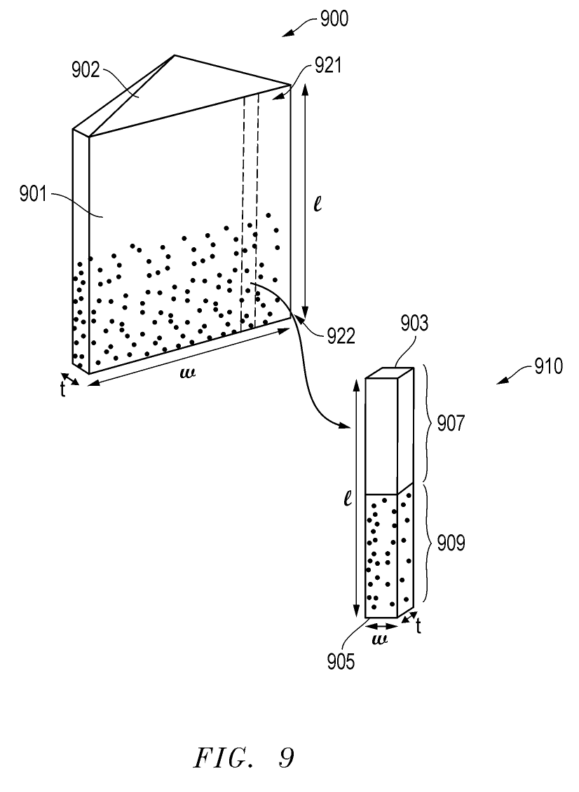

Referring to FIG. 8 a cylindrical, and particularly a tubular, single crystalline body 800 is illustrated. The single crystalline body 800 has a length (l), a diameter (d), and a thickness (t), as illustrated by the representative arrows. As will be appreciated, the length of such a single crystalline body 800 is comparable to the length of other single crystalline bodies provided herein irrespective of the contour. Moreover, the diameter of the single crystalline body 800 provided in FIG. 8 is also comparable to the width of other single crystalline bodies described herein. The thickness of the single crystalline body 800 is comparable to the thickness as described in accordance with other single crystalline bodies provided herein. It will be appreciated that while the single crystalline body 800 is illustrated as a tubular body, rod like or cylindrical bodies may also be formed without the hollow center according to embodiments herein.

Additionally, it will be appreciated that the processes and combination of components described herein may allow for simultaneous growth of the multiple crystals. That is, more than one die, each with a capillary and shaping channel, may be provided within a crucible such that multiple crystals can be grown simultaneously through multiple dies from the raw material within one crucible.

In reference to the composition of the rare earth silicate single crystals, as described previously, while the crystals can include various rare earth elements, typically the crystals are a lutetium silicate (LSO). Moreover, the single crystals formed are generally rare earth orthosilicates or rare earth pyrosilicates, particularly including at least one of Y, Ce, and Gd, in addition to Lu. As such, the rare earth orthosilicate single crystals formed herein can be described by the general formula Lu_{2-(a+b+c)}YₐCe_{b}Gd_{c}SiO₅, wherein the mol fraction of each of the components “a”, “b”, and “c” are as follows: 0≦a≦2, 0≦b≦0.2, and 0≦c≦2. According to another embodiment, the mol fraction of each of the components “a”, “b”, and “c” are as follows: 0≦a≦1, 0≦b≦0.02, and 0≦c≦0.01. Still, another particular embodiment utilizes mol fractions of each of the components “a”, “b”, and “c” as follows: 0≦a≦2, 0≦b≦0.02, and c=0.

Moreover, the rare earth pyrosilicate single crystals formed herein can be described by the general formula Lu_{2-(a+b+c)}YₐCe_{b}Gd_{c}SiO₇, wherein according to one embodiment, the mol fraction of each of the components “a”, “b”, and “c” are as follows: 0≦a≦2, 0≦b≦1, and 0≦c≦2. In a more particular embodiment, the components “a”, “b”, and “c” are within a range 0≦a≦1, 0≦b≦0.2, and 0≦c≦0.01. As such, generally the rare earth silicate single crystals have a monoclinic lattice structure. According to a particular embodiment, the single crystals have a monoclinic lattice structure particularly of the space group C2/c n° 15.

The rare earth silicate single crystals grown via EFG according to embodiments herein, and in particular, the doped rare earth silicate single crystals herein vary from other single crystals. That is, the EFG grown single crystals provided herein can be more homogeneous than single crystals grown using other processes, such as through a Czochralski process. Control of the homogeneity of particular EFG grown single crystals is attributed in part to the reduced segregation of certain species from the melt into the formed crystal. Notably, in the context of rare earth silicate single crystals grown through a Czochralski method, certain dopant species, such as for example cerium (Ce), are substantially segregated during the growth process such that the presence of such dopants throughout the volume of the crystal cannot be controlled.

It is recognized that Czochralski-grown single crystals exhibit a concentration gradient with respect to certain dopant species, and a segregation coefficient has been established with respect to certain species (i.e., Ce). The segregation coefficient is a measure of the ratio between the amount of the species within the crystal as compared to the amount of the species within the melt. It has been established that the segregation coefficient for Ce within a Czochralski-grown single crystal is about 0.25. A segregation coefficient of 0.25 indicates that Ce within Czochralski-grown single crystals prefers to stay within the melt. The preferential segregation of certain species within the melt leads to a gradient in the dopant concentration along the length of a Czochralski-grown boule. The inability to control the segregation of certain species in Czochralski-grown crystals, particularly key dopant species, such as cerium, results in the formation of crystals having inconsistent properties, particularly scintillation properties.

The gradient in the dopant concentration may be attributed to certain parameters, including the crystal fraction grown from the melt, which is related to the volume and mass, and the initial amount of the dopant within the melt. In the context of single crystals grown for industrial applications, the size of the crystal tends to be large, for example, crystals having a length of at least about 100 mm and a radius (or width) of at least about 16 mm. Moreover, the amount of the melt used to form the crystal (i.e., the crystal fraction) tends to be at least 40%, if not greater, and the initial amount of cerium added to such crystals is generally not greater than about 0.5 mol %.

The EFG-formed single crystals provided herein have enhanced homogeneity and a significantly low concentration gradient with respect to Ce, particularly in the context of large-scale single crystals grown for industrial applications having at least the parameters noted above. According to one particular embodiment, the EFG-formed single crystals can have a cerium concentration gradient of not greater than about 1.0×10⁻⁴ mol %/mm as measured along the length of the crystal representing the primary growth direction. The “primary growth direction” includes the dimension of the crystal associated with the length of the as-grown crystal body, illustrated in FIGS. 7 and 8 as the length “l”, otherwise what is typically the greatest dimension of the as-grown crystal. In another embodiment, the cerium concentration gradient can be less, such as not greater than about 5.0×10⁻⁵ mol %/mm, or even not greater than about 1.0×10⁻⁵ mol %/mm. In one particular embodiment, the average change in the cerium concentration over the length of the crystal in the primary growth direction is essentially zero.

By contrast, Czochralski grown single crystals, especially those grown for industrial applications having at least the parameters noted above, exhibit a concentration gradient typically greater than about 1.5×10⁻⁴ mol %/mm. See, for example, “The Effect of Co-Doping on the Growth Stability and Scintillation Properties of LSO:Ce”, by M. A. Spurrier et al., 15^{th} International Conference on Crystal Growth, August 2007. More typically, in the context of Czochralski-grown single crystal boules, the concentration gradient is generally greater.

Growth of the large, highly homogenous single crystals bodies facilitates the extraction of smaller crystals from the larger single crystal bodies, wherein the smaller crystals have the same degree of compositional homogeneity. Such extracted smaller single crystal bodies can have dimensions suitable for use in scintillation applications, such as pixels in positron emission tomography. For example, the extracted smaller single crystal bodies can have a generally rectangular shape with a cross sectional area as measured perpendicular to the length of not greater than about 10 mm². In other embodiments, smaller single crystal bodies can be extracted, such as single crystal bodies having a cross-sectional area of not greater than about 8 mm², or even not greater than about 6 mm². Still, the cross-sectional area is typically not less than about 2 mm². In particular, unlike other methods of growing, because of the high compositional homogeneity of the as-grown crystals in all directions, the extracted smaller single crystals can be extracted in a manner such that the length of the smaller crystals is a dimension extending substantially along the primary growth direction.

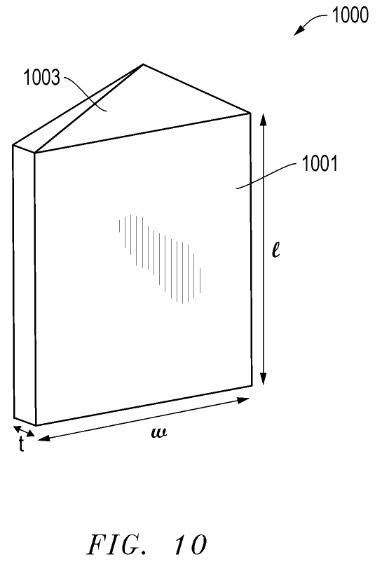

FIG. 9 includes an illustration of an as-grown EFG single crystal 900 having a body portion 901 and a neck portion 902. The single crystal body 901 has dimensions of thickness “t”, width “w”, and length “l”, wherein the thickness≦width≦length. In one particular embodiment, the single crystal body can be in the form of a sheet, having a generally rectangular shape, and having dimensions as described herein. The single crystal body 901 can include a first end 921 and a second end 922 separated by a distance equal to the length “l” of the single crystal body 901. Each of these dimensions can be the same as the dimensions of other large, as-grown single crystal bodies described herein.

Notably, the single crystal body 901 includes a purposefully engineered, non-homogenous composition, such that the composition along the length “l” of the single crystal body is intentionally altered. Generally, the composition along the length “l” of the single crystal body can be changed such that from the first end 921 of the single crystal body 901 to the second end 922 of the body 901, the composition is changed by not less than about one element. Such a process can be facilitated by a continuous feeding operation, wherein during formation of the single crystal body 901, the composition of the melt within the crucible is changed, such that at least one new element, or even an entirely different composition, can be added to the crucible to form a non-homogenous single crystal body 901 having two different compositions along the length “l”.

FIG. 9 further includes an illustration of a rare earth silicate single crystal body 910 extracted from the large as-grown rare earth silicate single crystal body 901. The smaller single crystal body 910 has a thickness “t”, a width “w”, and a length “l”, wherein the thickness≦width≦length. Generally, the single crystal body 910 has smaller dimensions, such that the body 910 has a cross-sectional area perpendicular to the length “l” (i.e., thickness×width) of not greater than about 16 mm². In other embodiments, the cross-sectional area can be less, such as not greater than about 10 mm², such as not greater than about 8 mm², or even not greater than about 6 mm². Still, the cross-sectional area is typically not less than about 2 mm².

The single crystal body 910 can include a first end 903 and a second end 905, wherein the first end 903 and the second end 905 are generally separated by the length “l” of the crystal body. In particular, according to one embodiment, the length “l” of the smaller single crystal body 910 is associated with the “l” of the as-grown single crystal body 901, and thus representative of the primary growth direction. In one embodiment, the smaller single crystal body 910 has a length “l” of not less than about 8 mm. In another embodiment the length “l” of the crystal body 910 is not less than about 15 mm, such as not less than about 20 mm, not less than about 30 mm, or even not less than about 40 mm. Still, the length of the extracted single crystal body 910 is generally not greater than about 100 mm.

Because the single crystal body 910 is extracted from the larger as-grown single crystal body 901, the single crystal body 910 can have an intentionally engineered change in composition along the length “l”. In one embodiment, the composition at the second end 905 is different by not less than one element as compared to the composition of the single crystal body 910 at the first end 903. For example, the rare earth silicate single crystal composition at the first end 903 can include a single crystal silicate material such as, lutetium silicate (LSO), yttrium silicate (YSO), and gadolinium silicate (GSO), while the composition of the single crystal body 910 at the second end 905 can include a silicate material having at least one different element. Thus, the single crystal body 910 can include an intentionally engineered non-homogenous composition, for example, LSO/LYSO (i.e., LSO at the first end/LYSO at the second end). The difference in the element can include the addition of a dopant. Some suitable dopants can include for example, yttrium or cerium, or a combination thereof. Accordingly, in one particular embodiment, the composition at the first end 903 can be essentially LSO and the composition at the second end 905 can be essentially LYSO, thus forming a non-homogenous single crystal having a composition of LSO/LYSO.

Generally, in such embodiments using a dopant, the dopant concentration is not greater than about 30 mol %. In other embodiments, the dopant concentration is less, such as not greater than about 15 mol %, such as not greater than about 10 mol %, or even not greater than about 5 mol %. In the particular context of a non-homogenous single crystal having a composition of LSO/LYSO, the dopant at the second end 905 is yttrium, and it can be present in an amount within a range between about 5 mol % and about 15 mol %.

Still, certain other embodiments can have intentionally engineered concentrations of other dopants, such as cerium, which may be present in particular amounts. For example, the first end 903 of the crystal body 910 can include a cerium-activated single crystal silicate material and the second end 905 of the crystal body 910 can include a cerium-activated single crystal silicate material having a different composition than the composition of the single crystal at the first end 903 by at least one element. In the context of cerium-activated silicate materials, the concentration of cerium within the silicate materials may be particularly low, such as not greater than about 5 mol %. In other cerium-activated silicate materials, the cerium concentration is not greater than about 2 mol %, or not greater than about 1 mol %, or even not greater than about 0.1 mol %. For example, in one particular embodiment, the first end 903 of the crystal body 910 can include cerium-activated LSO (Ce:LSO) and the second end 905 of the crystal body 910 can include cerium-activated LYSO (Ce:LYSO).

Moreover, in the context of cerium-activated silicate materials, the difference in cerium concentration from the first end 903 of the single crystal body 910 to the second end 905 of the single crystal body 910 can be engineered such that there is a difference of not less than about 0.1 mol %. Other embodiments can have a greater difference, such as not less than about 0.5 mol %, such as not less than about 1 mol %, or even not less than about 2 mol %. Generally, the difference is not greater than about 2 mol %.

The single crystal body 910 illustrates a top portion 907 having a first silicate composition and a bottom portion 909 having a different silicate composition by at least one element. While the top portion 907 and bottom portion 909 are illustrated as being substantially equal in volume, in other embodiments, the volume of portions within the single crystal having different compositions can be controlled. For example, in one embodiment, the top portion 907 has a volume of not greater than about 90% of the volume of the bottom portion 909. In other embodiments, the top portion has a volume of not greater than about 75%, or not greater than about 50%, or not greater than about 25% than the bottom portion 909. It will be appreciated, that such differences in volume can be reversed, such that the bottom portion 909 has a fraction of the volume of the top portion 907.

FIG. 10 includes an illustration of an as-grown rare earth silicate EFG single crystal 1000 having a body portion 1001 and a neck portion 1003 according to one embodiment. The rare earth silicate single crystal body 1001 can include silicate materials such as, lutetium silicate (LSO), yttrium silicate (YSO), gadolinium silicate (GSO), and scandium silicate (SSO), or any combination thereof. In addition to the silicate material, the rare earth silicate single crystal body 1001 can also include ytterbium (Yb). According to one embodiment, the single crystal body includes not greater than about 20 mol % Yb. In another embodiment, the single crystal body includes not greater than about 15 mol % Yb, such as not greater than about 10 mol % Yb, or even not greater than about 8 mol % Yb. Typically, the single crystal body includes not less than about 0.1 mol % Yb. Such crystals having a particular concentration of Yb, can generally be used in non-scintillator applications, such as optical applications, and more particularly, for use in lasers.

The single crystal body portion 1001 includes dimensions of thickness “t”, width “w”, and length “l”, wherein the thickness≦width≦length. Each of these dimensions can be the same as the dimensions of other as-grown single crystal bodies described herein. Moreover, in one particular embodiment, the single crystal body is formed as a sheet, having a rectangular cross-sectional shape and having dimensions described herein. Notably, the formation of such large rare earth silicate single crystals is facilitated by the use of particular devices and methods described herein.

Moreover, smaller single crystals can be extracted from the single crystal body portion 1001. Such smaller single crystals can also include dimensions of thickness “t”, width “w”, and length “l”, wherein the thickness≦width≦length. As such, in one embodiment, the smaller single crystal body can have a cross-sectional area perpendicular to the length of the body of not less than about 2 mm². In other embodiments, the cross-sectional area is greater, such as not less than about 4 mm², or not less than about 6 mm², or even not less than about 10 mm². Generally, the smaller extracted single crystal bodies have a cross-sectional area of not greater than about 16 mm².

### EXAMPLE 1

A rare earth silicate single crystal having the following composition Lu_{1.8892}Y_{0.11}Ce_{0.0008}SiO₅, was formed and of a substantially rectangular cross-sectional contour having the dimensions 5 mm×27 mm×203 mm (thickness×width×length). The crucible had a height of 35 mm and a diameter of 80 mm. The shaping channel had a thickness of 5 mm, a width of 27 mm, and a height of 1.3 mm, with a 120° angle between tapered sides of the capillary and shaping channel. The capillary had a thickness of 0.5 mm, a width of 27 mm, and a height of 40 mm. The following process flow was used to form such a crystal.
a. Cold charge the crucible with 750 g of a LYSO raw material (Lu_{1.8}Y_{0.2}SiO₅ doped with Ce) obtained from a LYSO crystal formed via a Czochralski method.
b. Purge the crystal growth chamber for 1 hour at 20 SCFH Argon and 0.1 SCFH Oxygen.
c. Turn on the power to 50 kW supply.
d. Ramp power at a rate of 0.05% per minute to a temperature set point of 2050° C.
e. Manually adjust the temperature (Tₘ) until melting is observed.
f. Manually adjust the temperature from Tₘ to Tₘ+20° C.
g. Lower a seed crystal and contact the seed to the surface of the melt within the die at a midpoint.
h. Adjust the temperature to a seeding temperature (Tₛ) and form 1 mm height of a liquid film between the seed crystal and the surface of the melt.
i. Begin pulling the crystal from the surface of the melt at 5 mm/hr.
j. Grow the neck of the crystal for a height of 5 mm and inspect the crystal for a uniform cross-section and crystalline quality
k. Adjust the temperature to a spreading temperature (Tₛₚ) to allow the crystal to spread to the edges of the shaping channel.
l. Adjust the temperature to maintain an average liquid film height across the length of the film of about 0.3 mm, while growing the body of crystal at 5 mm/hr.
m. Grow the body of crystal to a height of 203 mm.
n. Increase the pull rate to 1000 mm/hr to pull the crystal free of the film.
o. Annealing the crystal by keeping the temperature constant for 4 hours.
p. When crystal is 6 mm above the die, begin to ramp down the machine at a rate of 0.05% per minute until the output power is 0%.
q. Turn off the generator and allow the machine to cool for 5 hours before removing the crystal.

### EXAMPLE 2

A rare earth silicate single crystal having the following composition Lu_{1.8892}Y_{0.11}Ce_{0.0008}SiO₅, was formed and of a substantially rectangular cross-sectional contour having the dimensions 5 mm×102 mm×381 mm (thickness×width×length). The crucible had a height of 24 mm and a diameter of 116 mm. The shaping channel had a thickness of 5 mm, a width of 102 mm, and a height of 1.3 mm, with a 120° angle between tapered sides of the capillary and shaping channel. The capillary had a thickness of 0.5 mm, a width of 102 mm, and a height of 24 mm. The following process flow was used to form such a crystal.
a. Cold charge the crucible with 500 g of a LYSO raw material (Lu_{1.8}Y_{0.2}SiO₅ doped with Ce) obtained from a LYSO crystal formed via a Czochralski method.
b. Purge the crystal growth chamber for 1 hour at 20 SCFH Argon and 0.1 SCFH Oxygen.
c. Turn on the power to 50 kW supply.
d. Ramp power at a rate of 0.05% per minute to a temperature set point of 2050° C.
e. Manually adjust the temperature (Tₘ) until melting is observed.
f. Manually adjust the temperature from Tₘ to Tₘ+20° C.
g. Lower a seed crystal and contact the seed to the surface of the melt within the die at a midpoint.
h. Adjust the temperature to a seeding temperature (Tₛ) and form 1 mm height of a liquid film between the seed crystal and the surface of the melt.
i. Begin pulling the crystal from the surface of the melt at 5 mm/hr.
j. Grow the neck of the crystal for a height of 5 mm and inspect the crystal for a uniform cross-section and crystalline quality
k. Adjust the temperature to a spreading temperature (Tₛₚ) to allow the crystal to spread to the edges of the shaping channel.
l. Energize the feeding system to deliver the same LYSO raw material powder to the crucible at a rate of 1.6 g/min. and adjusting the temperature to maintain an average liquid film height across the width of the growing crystal of about 0.3 mm.
m. Adjust the temperature to maintain an average liquid film height across the length of the film of about 0.3 mm, while growing the body of crystal at 5 mm/hr.
n. Grow the body of crystal to a height of 304 mm.
o. Increase the pull rate to 1000 mm/hr to pull the crystal free of the film.
p. Annealing the crystal by keeping the temperature constant for 4 hours.
q. When crystal is 6 mm above the die, begin to ramp down the machine at a rate of 0.05% per minute until the output power is 0%.
r. Turn off the generator and allow the machine to cool for 10 hours before removing the crystal.

While rare earth silicate single crystals have been formed via EFG (See WO 2005/042812), such crystals have been limited in composition and size making their applications less suitable in commercial applications. Moreover, the inventors of the present application have overcome significant hurdles to the formation of commercially viable, rare earth silicate single crystals. Notably, the formation of such large, rare earth silicate single crystals via EFG demands unexpected changes to the process and devices, changes which would otherwise be counterintuitive, such as dimensional reduction of certain features within the growth chamber for improved process stability and compositional control of the single crystal. For example, in the migration from small, lab-sized EFG growth of rare earth silicates as disclosed in WO 2005/042812, it was found that capillary thickness had to be notably reduced, combined with controlled crucible depth according to embodiments herein. By further way of example, certain embodiments use a particular mass ratio of crystal mass to melt mass, processing environments, such as controlled oxygen partial pressures, and particular oxide-containing housing materials. Such parameters reduce unwanted material loss and compositional shift through sublimation. The additional control of compositional shift, in addition to other features, such as continuous feeding, facilitates the formation of large scale highly homogenous single crystal materials, but also the formation of large scale non-homogenous composite single crystals having different compositions along the length of the crystal.

Accordingly, the crystals, devices, and methods provided herein demonstrate a departure from the state of the art. The embodiments herein incorporate a combination of elements including an EFG process, and an EFG device utilizing particular components, materials, and designs suitable for melting and forming a rare earth silicate single crystal. Notably, the EFG device includes a crucible and die arrangement, including a capillary and shaping channel utilizing a combination of features including materials, dimension, and designs. Moreover, utilization of the EFG process facilitates formation of rare earth silicate single crystals having more uniform compositions as the segregation of particular species during the forming process is more readily controlled using the EFG process as opposed to the Czochralski method. In the particular context of single crystal rare earth silicates formed according to embodiments herein, such crystals are of suitable compositions and quality for use in a variety of applications, such as scintillators, and such crystals are produced with improved processability and limited post-growth machining and preparation.

It will be appreciated that the crystals as described herein can be used in a variety of applications. Particularly useful applications for such crystals generally include detection applications, ranging from industrial venues to more scientific venues such as the research and medical fields. For example, some detection applications include detection of particular particles or radiation, such as gamma rays or positron emissions. Particular detection applications within the medical industry may include tomography scanner systems (i.e., CT scans) or radiopharmaceutical applications. Some of the engineered, non-homogenous single crystals can have more particular uses in detection applications, such as for example in High Resolution Research Tomography (HRRT) having depth of interaction (DOI) capabilities. Still, some of the single crystal materials described herein are more suitable in non-scintillating applications. One such non-scintillating application includes optics, and more particularly the use of single crystals in laser applications.

While the invention has been illustrated and described in the context of specific embodiments, it is not intended to be limited to the details shown, since various modifications and substitutions can be made without departing in any way from the scope of the present invention. For example, additional or equivalent substitutes can be provided and additional or equivalent production steps can be employed. As such, further modifications and equivalents of the invention herein disclosed may occur to persons skilled in the art using no more than routine experimentation, and all such modifications and equivalents are believed to be within the scope of the invention as defined by the following claims.

1. A crystal comprising:
an Edge-defined Film-fed Growth (EFG) scintillator single crystal having a body, the body having a thickness, a width, and a length, wherein the thickness≦width≦length, the body having a cross-sectional area perpendicular to the length of not less than about 16 mm².

2. The crystal of claim 1, wherein the cross-sectional area of the body is not less than about 25 mm².

3. The crystal of claim 2, wherein the cross-sectional area of the body is not less than about 100 mm².

4. The crystal of claim 1, wherein the width of the single crystal body is not less than about 4 mm.

5. The crystal of claim 1, wherein the single crystal comprises a rare earth silicate.

6. The crystal of claim 5, wherein the rare earth silicate comprises at least one element selected from the group of elements consisting of Sc, Y, La, Ce, Pr, Nd, Sm, Eu, Gd, Tb, Dy, Ho, Er, Tm, Yb, and Lu.

7. The crystal of claim 6, wherein the rare earth silicate has the general formula Lu_{2-(a+b+c)}YₐCe_{b}Gd_{c}SiO₅, wherein 0≦a≦2, 0≦b≦0.2, and 0≦c≦2.

8. The crystal of claim 7, wherein the rare earth silicate has the general formula Lu_{2-(a+b+c)}YₐCe_{b}Gd_{c}Si₂O₇, wherein 0≦a≦1, 0≦b≦0.2, and 0≦c≦0.01.

9. The crystal of claim 1, wherein the crystal comprises a cerium concentration gradient of not greater than about 1.0×10⁻⁴ mol %/mm as measured along a length of the crystal representing a primary growth direction.

10-24. (canceled)

25. A scintillator single crystal comprising:
a rare earth silicate scintillator single crystal comprising a body, the body having a thickness, a width, and a length, wherein the thickness≦width≦length, the body having a first end and a second end separated from the first end by the length of the body, wherein the first end comprises a first composition and the second end comprises a second composition different than the first composition by not less than one element.

26. The scintillator single crystal of claim 25, wherein the first composition comprises a silicate material selected from the group of silicates consisting of lutetium silicate (LSO), yttrium silicate (YSO), and gadolinium silicate (GSO).

27. The scintillator single crystal of claim 25, wherein the second composition comprises a doped silicate material, wherein the dopant can include Y or Ce, or a combination thereof.

28. The scintillator single crystal of claim 25, wherein the second composition comprises a dopant concentration of not greater than about 30 mol %.

29. The scintillator single crystal of claim 25, wherein the first composition comprises essentially lutetium silicate (LSO) and the second composition comprises essentially lutetium yttrium silicate (LYSO).

30. A single crystal comprising:
an Edge-defined Film-fed Growth (EFG) rare earth silicate single crystal comprising Yb and having a body, the body comprising a thickness, a width, and a length, wherein the thickness≦width≦length.

31. The single crystal of claim 30, wherein the rare earth silicate single crystal comprises not greater than about 20 mol % Yb.
